(19) United States
(12) Patent Application Publication
(10) Pub. No.: US 2010/0100398 A1
(43) Pub. Date: Apr. 22, 2010

(54) SOCIAL NETWORK INTERFACE

(75) Inventors: Jeffrey David Auker, Coventry, CT (US); Laura O'Connor Hanson, Manchester, CT (US)

Correspondence Address: MCCORMICK, PAULDING & HUBER LLP, CITY PLACE II, 185 ASYLUM STREET, HARTFORD, CT, 06103, US

(73) Assignee: Hartford Fire Insurance Company, Hartford, CT (US)

(21) Appl. No.: 12/252,753

(22) Filed: Oct. 16, 2008

(51) Int. Cl. G06Q 40/00; G06Q 30/00

(52) U.S. Cl. 705/4; 705/319

(57) ABSTRACT

A system and method for providing online insurance quotes to a client on a social network web site includes an insurance server adapted to execute a coverage calculator application and an insurance database in communication with the insurance server for storing a plurality of personas, a plurality of insurance coverage options associated with each persona, and a price quote associated with each insurance coverage option. The system is in communication with a platform application on the social network web site. The platform application is in communication with a social network database for storing user content of the social network client. In one embodiment, the platform application uses an inference engine to query the user content of the social network client and return a set of inferred characteristics. The coverage calculator application selects a persona in response to the set of inferred characteristics and selects one of the insurance coverage options in response to the selected persona.

### FIELD OF THE INVENTION

The present invention relates to a system and method for providing insurance quotes and, more particularly, to a system and method for providing insurance quotes to users within a social network web site.

### BACKGROUND ART

Within the insurance industry, a typical process for providing an online insurance quote requires an applicant to access the insurance company's web site. Implicitly, the applicant must have started their online session intending to obtain insurance. Once at the insurance company's web site, the applicant then navigates through several screens, providing detailed information about him/herself and the risks to be protected. For example, a typical online request for automobile insurance requires the applicant to input name, address, zip code, date of birth, vehicle type, miles driven daily and annually, social security number, and driving history. Other typically required information includes the cost of the applicant's current policy, and coverage limits for separate coverages such as bodily injury liability, medical payments, uninsured and underinsured motorists coverage, comprehensive, collision, and rental reimbursement.

Once all the information is correctly input to the required fields, the applicant typically submits an email address and the quote is sent to the email account at a later time. In some processes, the applicant must contact the insurance company by telephone or may even be required to visit a local office in order to obtain a policy. Some processes allow purchasing a policy online.

One drawback to the existing process is that an extensive amount of information is required by the insurance company to generate a quote, and the applicant may not immediately know all the information. As a result, the applicant must stop or at least suspend the online quote process to look up the information. Consequently, the applicant may lose interest in the online quote process and abandon the process, resulting in a lost business opportunity for the insurance company.

Another drawback to the current process is that, rather than going to the specific web site of the insurance company, the applicant often will use a third party Internet search engine service to search for several potential sources of quotes for coverage. The insurance company then may have to pay the search engine service a premium to list the company's web site on the first page of search results.

Therefore, there is a need for quickly providing an insurance quote to an online user.

### SUMMARY OF THE INVENTION

According to the present invention, a system for providing online insurance quotes to a client on a social network web site is in communication with a platform application on the social network web site. The platform application is in communication with a social network database for storing user content of the social network client. The system includes an insurance server adapted to execute a coverage calculator application program and at least one insurance database in communication with the insurance server for storing a plurality of personas, a plurality of insurance coverage options associated with each persona, and a price quote associated with each insurance coverage option. The platform application is adapted to query the user content of the social network client and return a set of inferred characteristics to the insurance database. The coverage calculator application is further adapted to select a persona in response to the set of inferred characteristics, select one of the insurance coverage options in response to the selected persona, and display to the social network client the selected coverage and associated price quote.

One embodiment of the system further includes an inference engine executed by the platform application to query the user content of the social network client and return a set of inferred characteristics.

The present invention further includes a method for providing insurance quotes to a client on a social network website, the method including the steps of creating and storing, on a computer server, a plurality of personas, a plurality of insurance coverage options associated with each persona, and a price quote associated with each insurance coverage option. The method further includes the steps of accessing a database in communication with the social network web site, the database having user content specific to the client, querying the user content, returning a set of inferred characteristics, identifying one of the personas in response to the set of inferred characteristics, mapping the selected persona to at least one of the insurance coverage options, and displaying the insurance coverage options to the social network web site client.

### BRIEF DESCRIPTION OF THE DRAWINGS

FIG. 1 is a schematic diagram of a portion of a system for providing online insurance quotes according to an embodiment of the present invention;

FIG. 2 is a schematic diagram of an insurance server of the system shown in FIG. 1;

FIG. 3 is a schematic diagram of an insurance database for use in the system shown in FIG. 1;

FIG. 4 is a schematic diagram of another insurance database for use in the system shown in FIG. 1;

FIG. 5 is a block diagram of a method for providing insurance quotes to a client on a social network website according to the present invention;

FIG. 6 is a block diagram of a method for identifying a validated persona for use in the method of FIG. 5; and

FIG. 7 is a schematic diagram of an alternate embodiment of the system for providing online insurance quotes according to the present invention.

### DETAILED DESCRIPTION OF PREFERRED EMBODIMENTS

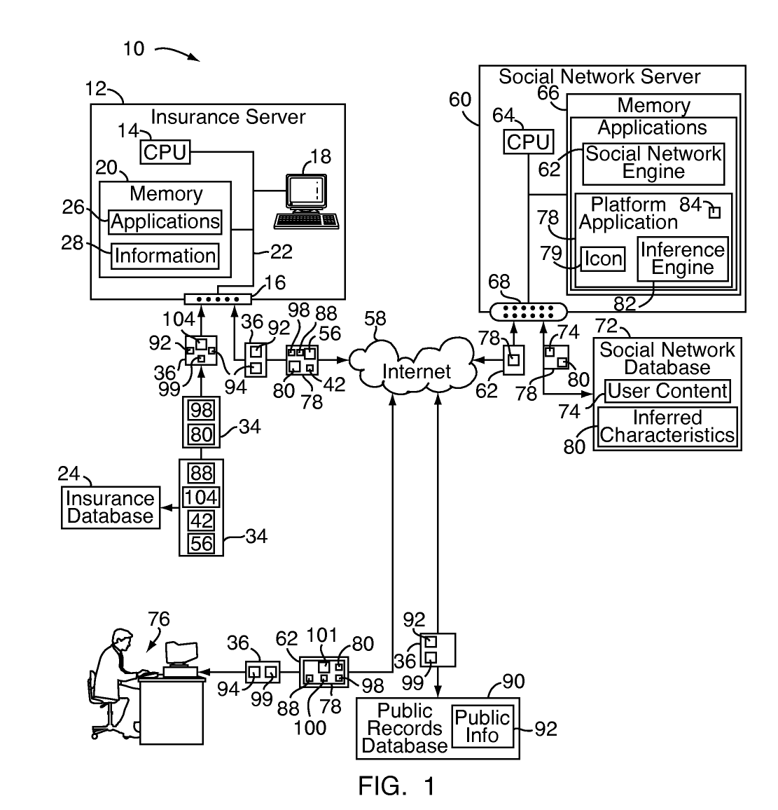

Referring to FIG. 1, a system 10 for providing online insurance quotes to a client on a social network web site includes at least one insurance server 12. The insurance server 12 includes at least one processor 14, e.g., CPU, an input/output (I/O) interface 16, I/O devices 18, and at least one memory 20. The elements are coupled together via a system bus 22 over which the various elements may interchange data and information. In addition, at least one insurance database 24 is in communication with the insurance server 12, as will be explained further below.

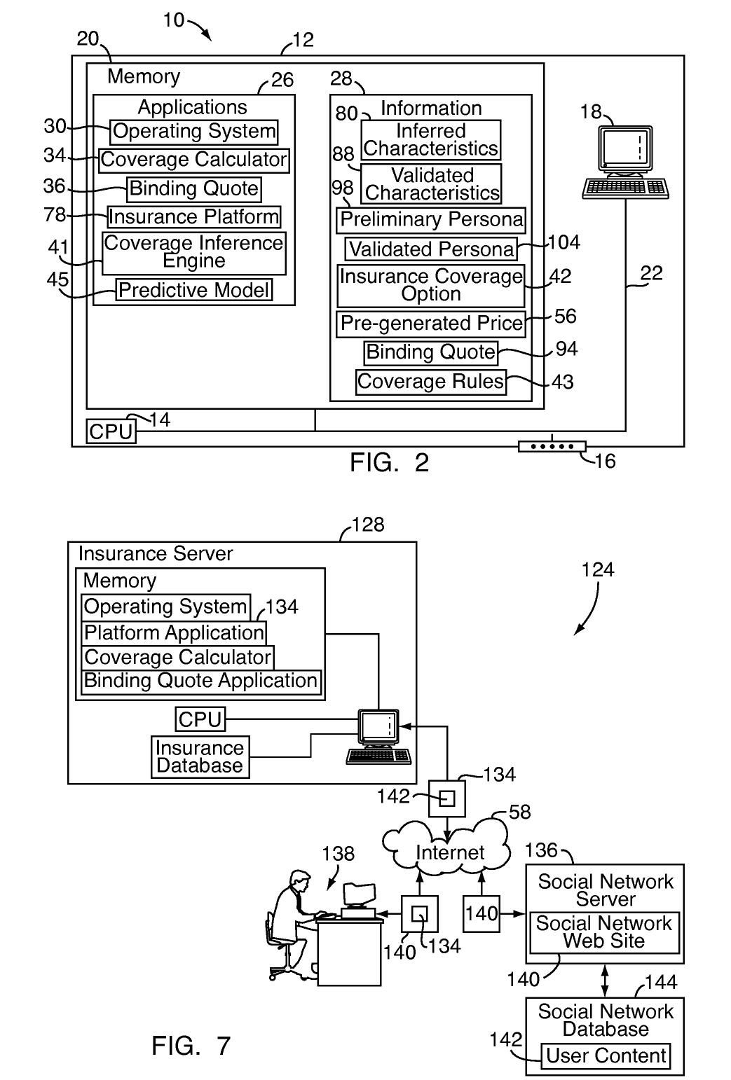

Referring to FIG. 2, the memory 20 includes applications 26 and information 28. The CPU 14 executes the applications 26 and uses the information 28 stored in memory 20 to control the operation of the system 10 and implement the methods of the present invention. Examples of applications 26 include an operating system 30, a coverage calculator application 34, and a binding quote application 36. Examples of information 28 stored in the memory 20 include system data from running applications 26, and user information such as configuration settings. I/O devices 18, e.g., displays, printers, keyboards, etc. display system information to a system administrator (not shown) and receive control and management input from the administrator.

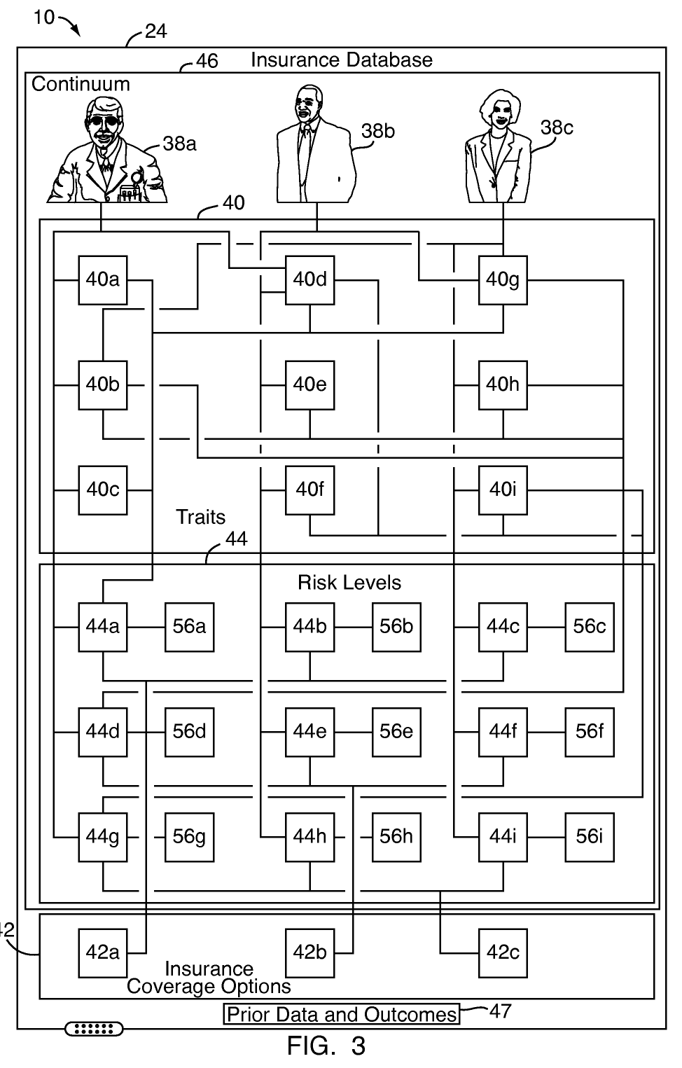

Referring to FIG. 3, the insurance database 24 includes a plurality of personas 38. Each of the plurality of personas 38 is defined by a set of traits 40. The insurance database 24 also includes a plurality of insurance products, packages, and coverage limits, hereinafter referred to as insurance coverage options 42. Each persona 38 further includes one or more risk levels 44 corresponding to each of the plurality of insurance coverage options 42. The risk level 44 corresponding to an insurance coverage option 42 for a particular persona 38 is determined based on the traits 40 deemed most relevant to the insurance coverage option 42. Together, the plurality of personas 38 generates a continuum 46 providing a broad selection of traits 40 and associated risk levels 44.

Each of the insurance coverage options 42 includes information regarding an insurance policy, product, or package, such as the variety of losses covered by the insurance product or package, and the damage limits and exclusions of the insurance product or package for each of the variety of losses. For example, a particular insurance coverage option 42 may include insurance products for life, automobile or other vehicle, homeowner's, personal property, umbrella liability, or any combination thereof, with or without specific exclusions for various events. In one embodiment, a coverage inference engine 41 determines the plurality of insurance coverage options 42 corresponding to each persona 38 by evaluating the traits 40 of each persona 38 according to coverage rules 43.

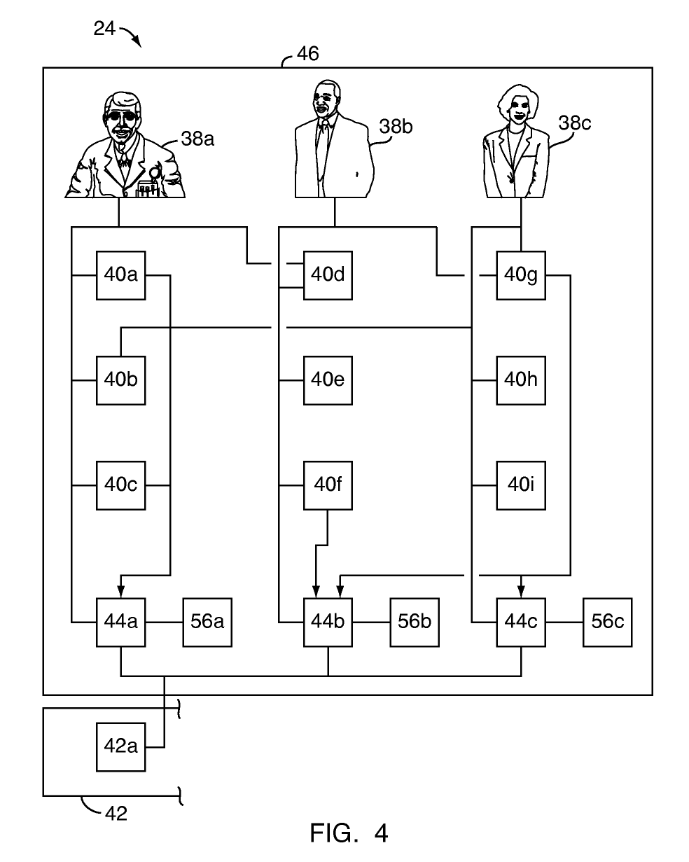

In the very simple example shown in FIG. 4, the plurality of personas 38 includes three personas 38a, 38b, and 38c. For this example, the insurance coverage options 42 are limited to automobile insurance coverage option 42a. The most relevant traits 40 of each persona 38, for assessing risk levels 44 relative to the automobile insurance coverage option 42a, may include age, gender, location of domicile, location of workplace, and type of insured vehicle. Other traits 40, possibly less relevant to automobile insurance, can include financial assets, education level, entertainment choices, vacation habits, employment history, and/or medical history. As shown in FIG. 4, the traits 40a, 40c, 40f, and 40g are particularly relevant to the group of risk levels 44 corresponding to the automobile insurance coverage option 42a. According to the traits 40 associated with each persona 38, each persona 38 has a corresponding risk level 44: persona 38a has a low risk level 44a, person 38b has a moderate risk level 44b, and persona 38c has a high risk level 44c.

In one embodiment, the risk levels 44 are determined based on the traits 40 using a predictive model 45. The predictive model 45 generally takes into account a large number of parameters. The predictive model 45, in various implementation, may include one or more of neural networks, Bayesian networks (such as Hidden Markov models), expert systems, decision trees, collections of decision trees, support vector machines, or other systems known in the art for addressing problems with large numbers of variables. Preferably, the predictive model 45 is trained on prior data and outcomes 47 known to the insurance company and stored in the insurance database 24. The specific data and outcomes 47 that are analyzed by the predictive model 45 vary depending on the desired functionality of the predictive model. In particular, depending on the insurance coverage option 42 for which the predictive model 45 is used to determine the risk levels 44, the specific data and outcomes 47 selected for training the predictive model 45 are determined by using regression analysis and/or other statistical techniques known in the art for identifying relevant variables in multivariable systems. The specific data and outcomes 47 can be selected from any of the structured data parameters stored in the insurance database 24, whether the parameters were input into the system originally in a structured format or whether they were extracted from previously unstructured text.

Referring back to FIG. 3, it is preferred that the continuum 46 includes at least three (3) personas 38 to provide for at least some degree of selection among the personas 38. There is no theoretical limit on the number of personas 38 provided within the continuum 46. A larger number of personas 38 is expected to result in broader and more finely-resolved distribution of risk levels 44 for the various insurance coverage options 42. However, currently available computer processor and memory resources are expected to impose a practical limit on the number of personas 38. Future improvements in computation resources are expected to raise this practical limit on the number of personas 38.

The insurance database 24, as shown in FIGS. 3 and 4, further includes a plurality of pre-generated price quotes 56 associated with the risk levels 44 and the insurance coverage options 42. For example, as best shown in FIG. 4, persona 38a has a risk level 44a for insurance coverage option 42a. Accordingly, persona 38a has a pre-generated price quote 56a for insurance coverage option 42a. The price quote 56a reflects current market rates and actuarial values based on the risk level 44a, and can be updated without changing the set of insurance coverage options 54.

Referring back to FIGS. 1 and 2, the I/O interface 16 couples the insurance server 12 to a computer network, other network nodes, or the Internet 58, as shown in FIG. 1. Specifically, the insurance server 12 is in communication with a social network server 60 executing a social network engine application, e.g., a social network web site 62. Exemplary social network web sites include Orkut™, LinkedIn™, Facebook™, or MySpace™. The social network server 60 includes a processor or CPU 64, memory 66, and an I/O interface 68 coupled together via a system bus 70 over which the various elements may interchange data and information. The social network server 60 communicates with a social network database 72. The social network database 72 stores user content 74 generated by or otherwise related to clients 76 of the social network web site 62.

Data intentionally posted to the social network web site 62 by each client 76 is termed self-declared user content 74. Examples of self-declared user content 74 include photos, profiles (including name, image, and likeness), messages, notes, text, information, music, video, and advertisements. In addition to being stored in the social network database 72, the self-declared user content 74 also can be published, displayed, transmitted, or shared with other users on the social network web site 62.

User content 74 also includes data automatically generated by the social network web site 62 and related to each client 76. For example, internet protocol (IP) addresses used for logon, duration and frequency of logon, and number of friends or contacts all can be considered as user content 74, although these data are not intentionally posted by the client 76.

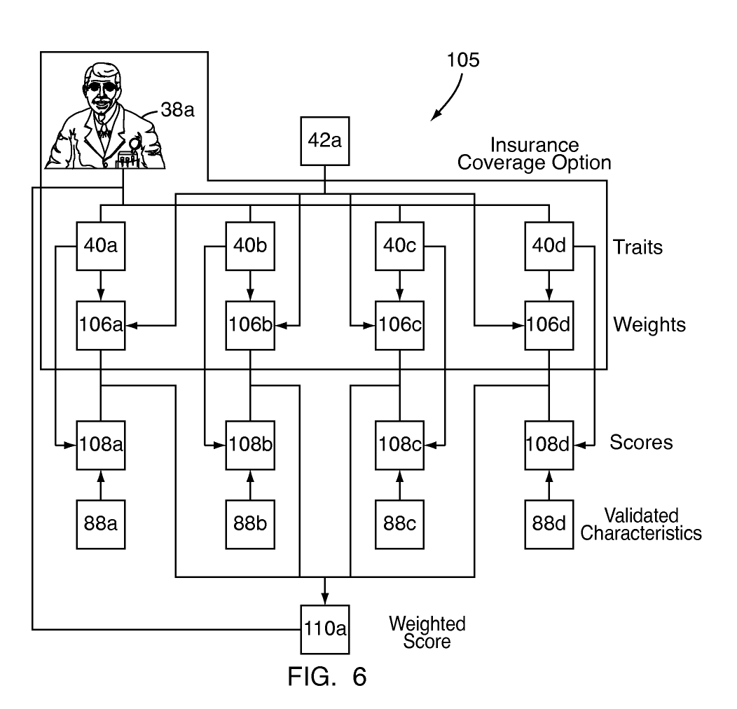

In the embodiment shown in FIG. 1, the social network server 60 is adapted to execute a platform application 78. The platform application 78 is represented on the social network web site 62 by an icon 79, communicates with the client 76, accesses the social network database 72, retrieves the user content 74, and generates inferred characteristics 80 based on the user content 74. Once extracted, the inferred characteristics 80 are communicated to the insurance server 12, as will be explained in further detail below with reference to FIG. 6.

In the majority of social network systems, the operator of a social network web site, such as the social network web site 62, grants permission to third party platform developers to provide platform applications, such as the platform application 78, through the social network web site as long as the developers abide by pre-defined terms of use. The platform applications can be hosted on a social network server, such as the social network server 60. More commonly, each platform application is hosted on a server external to the social network web site, such as the insurance server 12. Generally, each of the platform applications is granted access to user content under the condition that the content is used solely through an instance of the platform application for the client 76, and is not shared or exchanged with another party. In some cases, the user content 74 can be used by the platform application for a maximum of 24 hours, and then must be deleted.

Still referring to FIG. 1, the platform application 78 includes an user content inference engine 82 adapted to parse the user content 74 using rules 84 for generating inferred characteristics 80 of the client 76. For example, the user content inference engine 82 is adapted to generate from the user content 74 a set of inferred characteristics 80 such as the age, gender, domicile, and preferred driving vehicle of the client 76. Some of the inferred characteristics 80 may be available directly from the self-declared user content 74; others of the inferred characteristics 80 may be derived from image analysis or metadata related to the user content 74.

The coverage calculator application 34 is shown in FIG. 1 as being hosted on the insurance server 12, but can be hosted on any similar server. The coverage calculator application 34 receives the inferred characteristics 80 from the platform application 78, then determines which of the plurality of insurance coverage options 42 to recommend for the client 76 based on the inferred characteristics 80 or based on the user content 74. More specifically, the coverage calculator application 34 is adapted to match the client 76 to a preliminary persona 98 by comparing the inferred characteristics 80 to the traits 40 of some or all of the personas 38 in the continuum 46. The coverage calculator application 34 is further adapted to display the inferred characteristics 80 to the client 76, and to obtain validated characteristics 88 based on input or feedback from the client 76. Using the validated characteristics 88, the coverage calculator application 34 is adapted to match the client 76 to a validated persona 104. Using the inferred characteristics 80 or the validated characteristics 88, the coverage calculator application 34 is further adapted to invoke the coverage inference engine 41 for selecting a recommended insurance coverage option 100 from the plurality of insurance coverage options 42 corresponding to the validated persona 104, and to display to the social network client 76, through the social network web site 62 or by other means including e-mail, instant message, or text message, the selected insurance coverage option 100 and an associated pre-generated price quote 101, as will be explained in further detail below. Additionally, the coverage calculator application 34 is adapted to display to the client 76 a hyperlink or other means to access the binding quote application 36 hosted on the insurance server 12.

The binding quote application 36 is adapted to obtain additional personal information 99 from the client 76, and to query at least one public records database server 90 using the additional personal information 99, as can be seen from FIGS. 1 and 2. The public records database server 90 is accessed in traditional quoting applications, and stores detailed public information such as credit histories, driving records, department of motor vehicle records, court proceedings records, and personal property tax information. Some of the types of public records known to those of ordinary skill include NBR, motor vehicle department records, marshalls' records, court records, as-built construction filings, and global information systems. The binding quote application 36 is further adapted to retrieve data 92 pertinent to the client 76 by using the additional public information 99 and/or the validated characteristics 88 to query the public records database server 90. The binding quote application 36 additionally is adapted to produce a binding quote 94 based on the validated characteristics 88 and on the pertinent data 92.

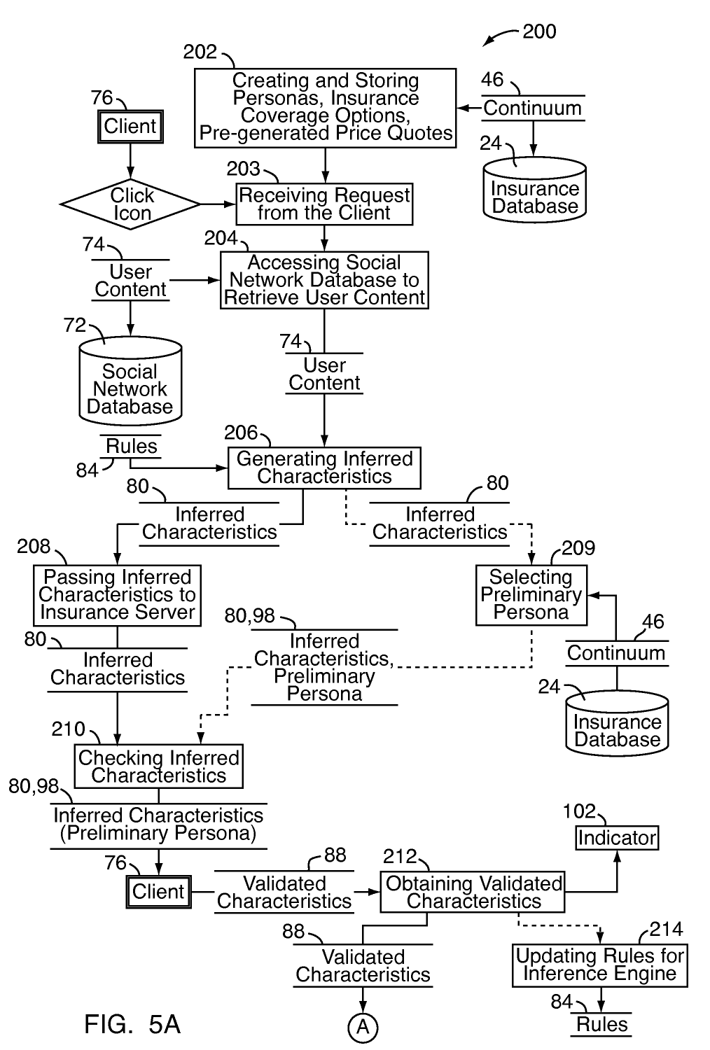

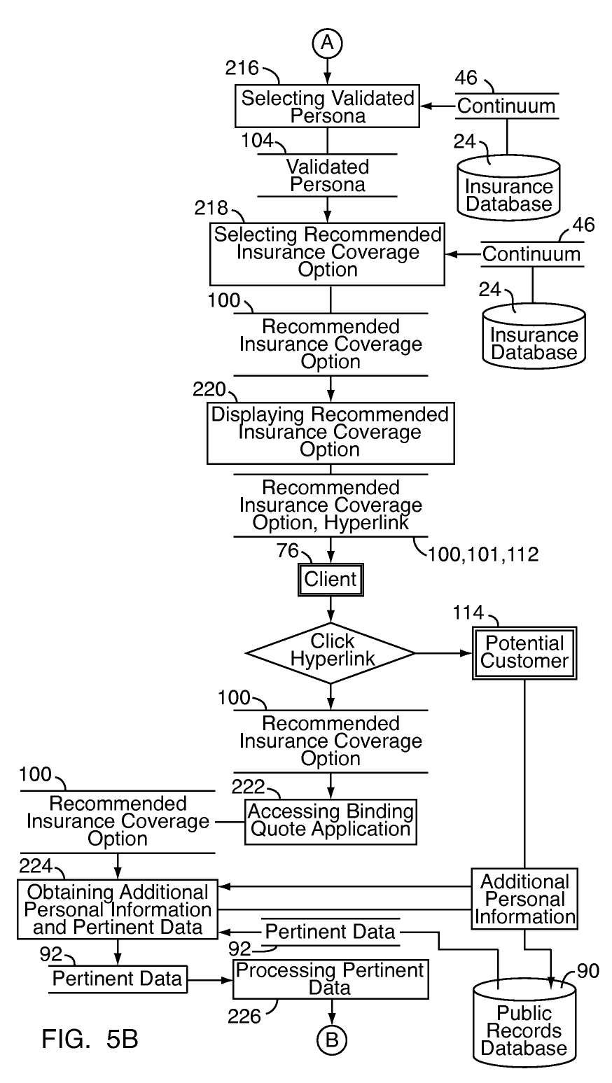

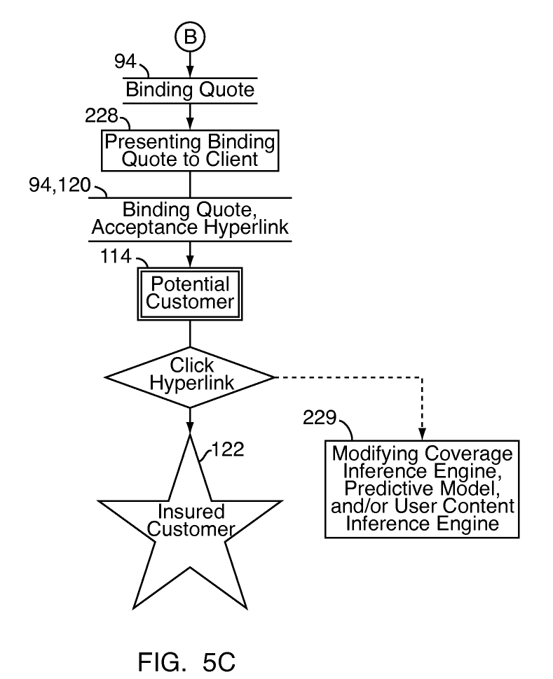

Referring to FIG. 5, a method 200 for providing the binding quote 94 to the client 76 of the social network web site 62 comprises a step 202 of creating and storing the plurality of personas 38 (shown in FIG. 3), the plurality of insurance coverage options 42, and the plurality of pre-generated price quotes 56 corresponding to the plurality of insurance coverage options 42 for each of the personas 38. The personas 38 fill the continuum 46, and are generated in a manner suitable to encompass a broad selection of the general population. Accordingly, most members of a group of clients 76 can be matched to appropriate personas 38.

For instance, referring also to FIG. 3, the plurality of personas 38 are developed iteratively at step 202 by combining variations of traits 40 and by generating a plurality of risk levels 44, corresponding to a plurality of insurance coverage options 42, for each persona 38. Each risk level 44 is obtained based on actuarial values for those traits 40 deemed most relevant to the particular insurance coverage option 42. For example, the plurality of coverage options 42 includes automobile insurance 42a. For automobile insurance 42a, the particular persona 38b may have a trait 40g that indicates a moderate level of risk 44b. Based on the insurance coverage option 42 and the risk level 44, a price quote 56 is associated with each insurance coverage option 42.

The variations of a particular trait 40 between different personas 38 are selected, for example, to obtain substantially uniform differences between values of a risk level 44 corresponding to each variation of the particular trait 40 for a chosen insurance coverage option 42. In other words, the risk level 44 for the chosen insurance coverage option 42 will progress substantially smoothly between adjacent personas 38 differing only in variations of the trait 40. Such a substantially smooth progression of risk level 44 is expected to enhance the ease of matching clients 76 to an appropriate persona 38, and also is expected to optimize the follow-on process of providing the binding quote 94.

Accordingly, variations of an age trait 40a might be chosen at 16, 17, 18, 21, 24, 27, 30, 35, 40, 45, 50, 55, 60, 65, 67, 70, and 72+ years in order to obtain substantially equal changes in actuarial risk level 44a for automobile insurance coverage option 42a between adjacent variations in the age trait 40a. However, each of the plurality of insurance coverage options 42 most likely will have a different actuarial risk level 44 associated with each variation of each trait 40. For example, life insurance coverage option 42b most likely would show a gradually increasing trend in corresponding risk level 44b through a range of ages 40a where automobile insurance coverage option 42a would most likely show a steady or slightly decreasing trend in corresponding risk level 44a. Thus, another method for selecting variations in the age trait 40a would be to seek, across all the insurance coverage options 42, substantially uniform average changes in risk levels 44 between adjacent variations in the trait 40. A third method would be to select variations in each of the traits 40 based on obtaining substantially uniform changes in the risk levels 44 for those insurance coverage options 42 for which the trait 40 is deemed most relevant.

Alternatively, constant-increment variations in the traits 40 could be chosen; for example, five (5) year increments of age 40a or ten (10) mile increments of daily driving distance 40b.

The method 200 further comprises a step 203 of receiving a request from the client 76, for example, receiving a click on the icon 79, as can be seen in FIG. 1.

Still referring to FIG. 5, the method 200 further comprises a step 204 of accessing the social network database 72. In the disclosed embodiment, the platform application 78 is generated and adapted to reside on the social network server 60, along with other applications. In a preferred embodiment, the platform application 78 is an open application programming interface (Open API) including the user content inference engine 82. When the client 76 activates the platform application 78, such as by clicking the icon 79 (shown in FIG. 1), the CPU 64 executes instructions to retrieve user content 74 made available through the social network web site 62.

The method 200 further comprises a step 206 of querying, filtering, and/or sorting the user content 74 according to the rules 84 to generate inferred characteristics 80 for use by the coverage calculator application 34. For example, the inferred characteristics 80 can include the gender and age range of, the type of vehicle owned by, or the type of insurance coverage option 42 best suited to the client 76. If the inferred characteristics 80 cannot be extracted directly from specific data fields in the user content 74, pattern recognition software may be used to determine the inferred characteristics 80. For example, image or text analysis software may be employed to generate textual or numeric information, such as the condition, model year, or maintenance history of the vehicle owned by the client 76, from digital images or textual data within the user content 74.

In a preferred embodiment, the platform application 78 uses the user content inference engine 82 to generate the inferred characteristics 80 at the step 206. In one example, the user content inference engine 82 employs a forward chaining approach wherein inferences are drawn from the available user content 74 based on rules 84. For example, the user content 74 may include a biographical section on the client 76 and a list of third-party platform applications selected by the client 76. Information obtained from the biographical section, such as birth date or high school graduation year, is used to infer age and an expected fitness level according to one or more of the rules 84. The rule for expected fitness level can further adjust the expected fitness level if, for example, the user content 74 includes an exercise journal tracking an exercise program followed by the client 76. As another example, user content 74 related to hobbies such as sky-diving can be used to infer that the client 76 is best matched with one of a group of personas 38 sharing certain traits 40. As another example, the user content 74 may include posted images including photographs. By comparing each of the posted images to an image library, and/or by parsing the metadata of each posted image, the platform application 78 can infer additional information about the client 76. As a further example, the user content 74 may include group affiliations, tagged websites, or fan identifications. This affiliation information can be compared directly to Boolean (true/false) traits 40 of the personas 38.

In a more detailed example, referring back to FIG. 3, an individual who is 65 years old, female, lives in rural Wisconsin, works from home, has a clean driving record, and owns a seven-year-old sedan would most likely be matched to the low-risk persona 38a. Contrarily, an eighteen-year-old male living in urban Dallas and leasing a bright yellow sports car with a rear spoiler and spinner hubcaps would most likely be matched to the high-risk persona 38c. While detailed information on vehicle accessories might not be available simply from a VIN, social networking sites frequently include photographs from which such information can be obtained. Information that cannot be obtained regarding any of the traits 40 can be ignored in matching the client to one of the personas 38.

The user content inference engine 82 may alternately, or simultaneously, employ a backward chaining approach wherein traits 40 particular to a persona 38 are compared to the user content 74. For example, a persona 38a, having a low risk 44a for automobile insurance coverage option 42, may include at least some of the following traits 40: female, age 55-65, rural address, vehicle worth less than $20,000. While parsing the user content 74, the platform application 78 can check whether any of the traits 40 are matched. Based on backward chained matching of traits 40 ot the user content 74, the platform application 78 can select progressively narrower sets of personas 38. Often, rules 84 are employed to aid in this determination. For example, if the make and model of the client's automobile are ascertainable from the user content 74, a vehicle dollar value characteristic can be established for comparison to a vehicle dollar value trait. Due to the large number of outcomes (characteristics) that must be checked against the available user content 74, the backward chaining approach can become cumbersome using current computational technology. For this reason, a forward chaining approach currently is preferred. However, it is expected that future developments will enable expanded use of the backward chaining approach.

Referring again to FIG. 5, the method 200 further comprises a step 208, in which the platform application 78 passes the inferred characteristics 80 through the I/O interfaces 56 and 16 to the insurance server 12, which stores the inferred characteristics 80 in the insurance database 24 for use by the coverage calculator application 34. In an exemplary embodiment wherein an user content inference engine 82 is used to generate the inferred characteristics 80, steps 206 and 208 can be combined with an optional step 209 so that the platform application 78 immediately passes each inferred characteristic 80 to the coverage calculator application 34 for incremental matching.

At the optional step 209, the coverage calculator application 34 can select increasingly narrow subsets of personas 38 from the continuum 46, based on each additional inferred characteristic 80. An initial subset of personas 38 includes the entire continuum 46. As each inferred characteristic 80 is generated, the coverage calculator application 34 excludes personas 38 that exceed an acceptable measure of difference from the newly inferred characteristic 80. When the final inferred characteristic 80 has been passed to the coverage calculator application 34, the coverage calculator application 34 identifies the preliminary persona 98. Although this incremental matching embodiment offers efficient use of computation resources, this embodiment also introduces a risk of mismatching the client 76 to an inappropriate preliminary persona 98 based on the order of generating the inferred characteristics 80.

The method 200 further comprises a step 210 of checking the inferred characteristics 80 for accuracy. In one example, the platform application 78 displays the inferred characteristics 80 to the client 76. Alternatively or additionally, the coverage calculator application 34 can pass the preliminary persona 98 to the platform application 78. The platform application 78 then can display the preliminary persona 98 for approval by the client 76.

The method 200 further comprises a step 212 of obtaining validated characteristics 88, whereby the client 76 can update or correct any errors in the inferred characteristics 80. The platform application 78 can track the number and the significance of the differences between the inferred characteristics 80 and the validated characteristics 88. For example, the user content inference engine 82 may infer from the user content 74 that the client 76 lives in urban Dallas, leases a bright yellow sports car having a rear spoiler and spinner hubcaps, and frequently drives from Dallas to Chicago in less than twenty four (24) hours. However, the client 76 may update these inferred characteristics 80 to provide validated characteristics 88 indicating that he/she drives a seven-year-old station wagon at moderate speeds and only within five miles of his/her domicile. The platform application 78 then sets a value of an indicator 102 based, for example, on the difference between actuarial values related to the inferred characteristics 80 and actuarial values related to the validated characteristics 88.

In one embodiment of the present invention, the method 200 further comprises a step 214 whereby the rules 84 used by the user content inference engine 82 to generate the inferred characteristics 80 are updated based upon differences between the inferred characteristics 80 and the validated characteristics 88. For example, the rule for expected fitness level may be updated if clients in a particular age range, having a particular set of inferred characteristics 80, consistently indicate an exercise pattern different from the average activity level presumed by the rule for expected fitness level. In this manner, the inference engine “learns” to generate more accurate inferences in the future.

The method 200 further comprises a step 216 of selecting a validated persona 104 based on the validated characteristics 88. The validated persona 104 has traits 40 that provide a close over-all match to the validated characteristics 88. One example method to identify the validated persona 104 is a weighting method 105, as shown in FIG. 6. Each trait 40 is given a weight 106 depending on the actuarial relevance of the trait 40 to each of the plurality of insurance coverage options 42. For each trait 40, the coverage calculator application 34 then generates a score 108 by comparing that trait to one of the validated characteristics 88. The coverage calculator application 34 then calculates a weighted score 110 for each persona 38, based on the weights 106 and the scores 108 for each trait 40. The highest weighted score indicates the validated persona 104 having a combination of traits 40 that provides the closest overall match to the validated characteristics 88.

Referring again to FIG. 5, the method 200 further comprises a step 218 of selecting the recommended insurance coverage option 100 from the plurality of insurance coverage options 42 corresponding to the validated persona 104, based on the inferred characteristics 80 or on the validated characteristics 88.

For example, referring also to FIG. 3, the inferred characteristics 80 may include information that the client 76 owns more than one vehicle, works as a professional, owns a primary house and summer home, and has a spouse and children. In this instance, the coverage calculator application 34 would select as the recommended insurance coverage option 100 the insurance coverage option 42c including products for homeowner coverage, automobile coverage, and excess liability insurance coverage over and above the homeowner and automobile coverage (an umbrella policy). In another example, the inferred characteristics 80 may include information that the client 76 is single, attends college, and lives with his/her parents. In this instance, the coverage calculator application 34 would select as the recommended insurance coverage option 100 the insurance coverage option 42a offering only automobile insurance coverage.

Referring back to FIG. 5, the method 200 further comprises a step 220 of displaying the recommended insurance coverage option 100 and the associated pre-generated price 101 to the client 76 via the social network web site 62. The pre-generated price quote 101 is not binding, but merely represents an estimated range from the information inferred. Accordingly, at the step 220 the platform application 78 also provides a purchase hyperlink 112 by which the client 76 can access the binding quote application 36 hosted on the insurance server 12.

The method 200 further comprises a step 222, wherein the client 76 clicks the purchase hyperlink 112, accesses the binding quote application 36, and becomes a potential customer 114 for the recommended insurance coverage option 100. The binding quote application 36 can be optimized to minimize the amount of personal information requested from the potential customer 114 in order to provide a binding quote 94.

The method 200 further comprises a step 224 of obtaining additional personal information 99 and pertinent data 92. In one example, the binding quote application 36 requests the additional personal information 99. As a further example, at the step 224 the potential customer 114 can supply a vehicle identification number (VIN) to the binding quote application 36. The binding quote application 36 then communicates with the at least one public records database server 90 to retrieve pertinent data 92 related to the additional personal information 99.

The method 200 further comprises a step 226 of processing the pertinent data 92 and/or the additional personal information 99 to generate the binding quote 94 for automobile insurance. For example, at the step 226, the binding quote application 36 may modify the recommended insurance coverage option 100 based on the additional personal information 99, which may include changes to the recommended insurance coverage option 100 proposed by the potential customer 114.

The method 200 further comprises a step 228 of presenting the binding quote 94 to the potential customer 114 along with an acceptance hyperlink 120. By clicking the acceptance hyperlink 120, the potential customer 114 electronically signs a contract containing all terms of the binding quote 94, thus becoming an insured customer 122. If the acceptance hyperlink 120 is not clicked, the platform application 78 saves the binding quote 94 in the user content 74 and/or the binding quote application 36 saves the binding quote 94 in the insurance database 24 in association with the validated characteristics 88. The binding quote 94 remains valid during a certain pendency period after issuance to the client, even if market rates or actuarial value tables change during the pendency period.

At an optional step 229, after the potential customer 114 clicks the acceptance hyperlink 120, the binding quote application 36 may modify the coverage inference engine 41, the predictive model 45, and/or the user content inference engine 82, based on the pertinent data 92 and/or the additional personal information 99. For example, if the pertinent data 92 associated with the potential customer 114 indicates that, contrary to expectations, a lessee of a bright yellow sports car has a lower-than-average rate of automotive collision claims, then the predictive model 45 could be adjusted accordingly.

One advantage of the present system is that the odds of the client 76 becoming the potential customer 114 and obtaining the binding quote 94 from the insurance company are greatly increased because the client 76 does not have to seek out the insurance company's web site. Indeed, the client 76 need not have any particular intent to obtain insurance coverage until presented with the icon 79 through the social network web site 62. The client 76 need only click on the icon 79 to get started, and will be directed exclusively to the insurance company's quote. In contrast, the traditional method of using an Internet search engine to obtain a quote leads a potential client to dozens of possible insurance companies.

Another advantage of the present system and method is that social network web sites typically permit or encourage “viral marketing” to advertise services. Additionally, social network web sites often permit platform applications to report the related activities of each client to the friends and contacts of the client. Thus, the social network web site 62 may permit the platform application 78 to automatically inform friends and contacts of the client 76 when the client 76 becomes a potential customers 114 or an insured customer 122. This sort of automated word-of-“mouth” marketing can enhance the effectiveness of the insurance company's marketing expenditures.

Yet another advantage of the present system is that the potential customer for insurance coverage 114 does not have to input a great deal of information in order to obtain the binding quote 94. Thus, the potential customer 114 is more likely actually to complete the insurance quote process and to accept the binding quote 94, thereby becoming an insured customer 122.

Thus, by using the invention disclosed herein, the insurance company can target social network web site clients 76 through the familiar interface of the social network web site 62, and can streamline the quoting process so as to efficiently transform a client 76 into an insured customer 122, thereby resulting in a greater number of people who initiate and complete an online process to obtain insurance.

Although this invention has been shown and described with respect to the detailed embodiments thereof, it will be understood by those skilled in the art that various changes in form and detail thereof may be made without departing from the spirit and scope of the invention.

For example, although the system 10 depicted in FIG. 1 includes the social network server 60 adapted to execute the platform application 78, other embodiments of the social network interface are within the scope of one of ordinary skill. Referring to FIG. 7, a system 124 includes an insurance server 128, which is adapted to execute a platform application 134. The platform application 134 connects to a social network server 136 via I/O interfaces 132 and 133. Through the social network server 136, the platform application 134 communicates with a client 136 of a social network web site 140 hosted on the social network server 136, and accesses user content 142 from a social network database 144.

What is claimed is:

1. A system for providing insurance quotes to a client of a social network web site hosted on a social network server and having an associated social network database, the system being in communication with the social network server, the system comprising:
at least one insurance database for storing a plurality of personas, a plurality of insurance coverage options associated with each persona, and a price quote associated with each insurance coverage option; and
an insurance server adapted to execute at least one of a coverage calculator application and a platform application, the platform application communicating with the client through the social network web site and accessing user content associated with the client in the social network database, the platform application generating inferred characteristics associated with the client based on the user content, the coverage calculator application selecting a persona and one of the plurality of corresponding insurance coverage options based on the inferred characteristics, and the platform application transmitting to the client the selected insurance coverage option and the associated price quote.

2. The system of claim 1 wherein the platform application includes a user content inference engine for inferring the inferred characteristics.

3. The system of claim 2, the server being further adapted to modify the user content inference engine based on client input.

4. The system of claim 1, further comprising a second server adapted to execute one of the coverage calculator application and the platform application.

5. The system of claim 3, wherein the second server is the social network server.

6. The system of claim 1, the platform application validating the inferred characteristics based on client input.

7. The system of claim 1 wherein the insurance server is further adapted to execute a binding quote application for querying the client to obtain additional personal information, and for presenting a binding quote for insurance based on the additional personal information and/or pertinent data obtained therefrom.

8. The system of claim 7, further comprising a public records database server in communication with the insurance server, the insurance server being adapted to obtain pertinent data from the public records database server based on the additional personal information.

9. The system of claim 1, wherein each persona is defined by traits, and the price quotes associated with each insurance coverage option are generated by a predictive model based on selected traits of each persona.

10. An online insurance quoting system for communicating with a client of a social network web site, the system comprising:
at least one insurance database for storing a plurality of personas, a plurality of insurance coverage options associated with each persona, and a price quote associated with each insurance coverage option; and
a server adapted to execute a platform application, including a user content inference engine for searching the social network web site to obtain user content associated with the client and for generating inferred characteristics based on the user content, the server further adapted to communicate with the client through the platform application, to match one of the personas to the inferred characteristics, to retrieve the plurality of insurance coverage options corresponding to the matched persona, to recommend an insurance coverage option from the retrieved plurality of insurance coverage options, and to display the recommended insurance coverage option and an associated price quote to the client.

11. The system of claim 10 wherein the server is further adapted to modify the recommended insurance coverage option based on additional personal information associated with the client.

12. The system of claim 10, wherein the server is further adapted to execute a binding quote application for querying the client for additional personal data, and for presenting a binding quote for insurance based on the additional personal data or information derived therefrom.

13. The system of claim 12, wherein the additional personal data includes a vehicle identification number.

14. The system of claim 10, wherein the server is further adapted to execute a coverage inference engine for recommending an insurance coverage option based on traits of the selected persona.

15. The system of claim 14, wherein the server is further adapted to modify the coverage inference engine based on additional personal information associated with the client.

16. A computerized method for providing insurance quotes to a client of a social network web site, the method including the steps of:
storing, in an insurance database, a plurality of personas, a plurality of insurance coverage options associated with each persona, and a price quote associated with each insurance coverage option;
accessing a social network database in communication with the social network web site;
retrieving from the social network database user content specific to the client;
selecting one of the personas based on the user content;
recommending one of the plurality of insurance coverage options corresponding to the matched persona; and
transmitting the recommended insurance coverage option and an associated price quote to the social network web site.

17. The method according to claim 16, wherein the personas are defined by traits, and the step of selecting one of the personas includes the steps of parsing the user content, generating inferred characteristics based on the user content, comparing the inferred characteristics to the traits associated with at least a selected group of the personas, and selecting a preliminary persona having traits most closely matched by the inferred characteristics.

18. The method according to claim 16, wherein the plurality of insurance coverage options associated with each persona are generated by a coverage inference engine based on the traits defining the persona.

19. The method according to claim 16, wherein at least the steps of accessing the social network database, retrieving the user content, parsing the user content, and generating the inferred characteristics are performed by an open application programming interface.

20. The method according to claim 16, further comprising the steps of:
displaying the inferred characteristics to the client on the social network website;
obtaining client input in response to the inferred characteristics;
generating validated characteristics based on the inferred characteristics and on the client input; and
selecting a validated persona based on the validated characteristics.

21. The method according to claim 20, wherein at least the steps of accessing the social network database, retrieving the user content, and selecting a persona are performed by an open application programming interface.

22. The method according to claim 21, wherein the open application programming interface includes a rule-based user content inference engine.

23. The method according to claim 22, further comprising the step of updating the user content inference engine rule base in response to the validated characteristics.

24. The method according to claim 16, wherein the step of selecting one of the personas includes the steps of parsing the user content, checking whether traits of each persona match the user content, and selecting progressively narrower sets of personas based on matching traits to the user content.
